(19) United States
(12) Patent Application Publication
(10) Pub. No.: US 2005/0129021 A1
(43) Pub. Date: Jun. 16, 2005

(54) Packet header verification

(76) Inventors: N. Ranjith Kumar, Kamataka (IN); Ramesh R. Phatak, Kamataka (IN)

Correspondence Address: BUCKLEY, MASCHOFF, TALWALKAR LLC, 5 ELM STREET, NEW CANAAN, CT, 06840, US

(21) Appl. No.: 10/736,302

(22) Filed: Dec. 15, 2003

(51) Int. Cl. H04L 12/56

(52) U.S. Cl. 370/392; 370/474

(57) ABSTRACT

According to some embodiments, information packet header portions are checked using pre-determined relationships and associated stored patterns.

### BACKGROUND

A network device may facilitate an exchange of information packets. For example, a network processor may receive packets of information, process the packets, and arrange for packets to be transmitted to an appropriate destination through a network (e.g., to a remote network device). Moreover, it may be helpful to avoid unnecessary delays when processing the packets—especially when the network device is associated with a relatively high speed network. For example, unnecessary delays might degrade the performance of a network processor (e.g., a processor that is adapted to process information packets at a faster rate as compared to a general purpose processor).

### BRIEF DESCRIPTION OF THE DRAWINGS

FIG. 1 is a block diagram of a network device.

FIG. 2 illustrates an information packet according to some embodiments.

FIG. 3 illustrates a packet header portion database according to some embodiments.

FIG. 4 illustrates packet header check database according to some embodiments.

FIG. 5 is a flow chart of a method according to some embodiments.

FIG. 6 is a block diagram of a network processor according to some embodiments.

FIG. 7 is a flow chart of a method according to some embodiments.

FIG. 8 illustrates an IPv4 packet header portion database according to one embodiment.

FIG. 9 illustrates an IPv4 packet header check database according to one embodiment.

FIG. 10 illustrates a network processor according to some embodiments.

FIG. 11 is an example of a system according to some embodiments.

### DETAILED DESCRIPTION

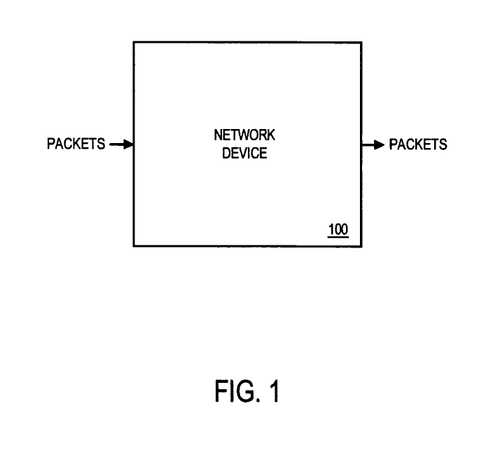

A network device may facilitate an exchange of information packets through a network. For example, as illustrated in FIG. 1 a network device 100 may receive and transmit information packets. As used herein, the phrase “network device” might refer to, for example, an apparatus that facilitates an exchange of information via a network, such as a Local Area Network (LAN), a Wide Area Network (WAN), or an Internet Protocol (IP) network. Moreover, a network device might facilitate an exchange of information packets in accordance with the Fast Ethernet LAN transmission standard 802.3-2002® published by the Institute of Electrical and Electronics Engineers (IEEE). Similarly, a network device may process and/or exchange Asynchronous Transfer Mode (ATM) information in accordance with ATM Forum Technical Committee document number AF-TM-0121.000 entitled “Traffic Management Specification Version 4.1” (March 1999). According to some embodiments, the network device processes and/or exchanges Synchronous Optical Network (SONET) information via an Optical Carrier level (OC) 48 or OC-192 network as specified in “Digital Hierarchy—Optical Interface Rates and Formats Specification, American National Standards Institute (ANSI) document T1.105 (1991).

The network device 100 may be associated with, for example, a network processor, a switch, a router (e.g., an edge router), a layer 3 forwarder, and/or protocol conversion. Examples of network devices include those in the INTEL® IXP 2400 family of network processors.

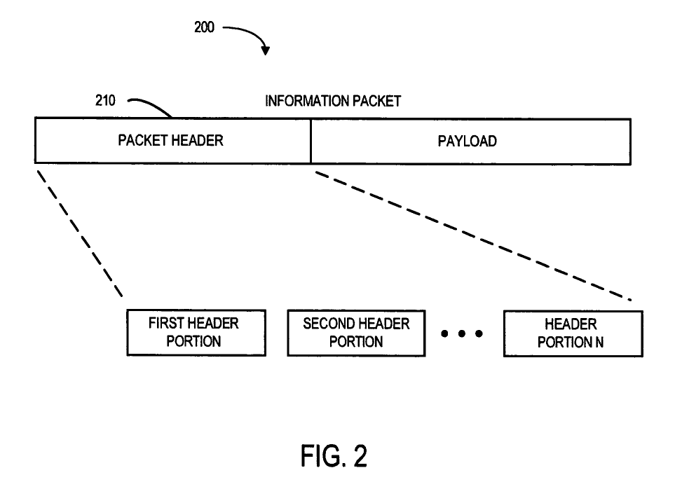

The network device 100 may receive packets of information (e.g., IP datagrams), process the packets, and arrange for packets to be transmitted to an appropriate destination (e.g., to a remote network device). As illustrated in FIG. 2, each packet may include a “packet header” 210 and a remaining information portion or “payload.” The packet header 210 may, for example, include a source address (e.g., indicating where the packet came from), a destination address (e.g., indicating where the packet is traveling to), information about the length of the packet, and other information that may be used to process the packet.

When processing a packet, the network device 100 performs a “header verification” process. That is, information in the packet header 210 may be checked to make sure that the information is valid (e.g., to make sure that an IP address is not an invalid address).

Consider, for example, a packet header associated with Internet Protocol version 4 (IPv4) as defined by the Internet Engineering Task Force (IETF) Request For Comment (RFC) 1730 entitled “Internet Message Access Protocol—Version 4” (1994). In this case, the packet header may need to comply with the IETF Network Working Group RFC 1812 document entitled “Requirements for IP Version 4 Routers” (June 1995) and the RFC 2644 document entitled “Changing the Default for Directed Broadcasts in Routers” (August 1999).

One header portion in an IPv4 packet header is the 32-bit “IP address,” which is not allowed to have certain numerical values. In particular, the IP address cannot equal: FF.FF.FF.FF, 00.XX.XX.XX, 7F.XX.X.XX, EX.XX.XX.XX (reserved to indicate a Class D address), or FX.XX.XX.XX (reserved to indicate a Class E address) where X represents four “don't care” bits. In this case, the network processor could perform the following header verification process to determine whether or not the IP address is valid:

```
IPv4_address_verify (result, ip_address)
{
/*Check whether ip_address equals FF.FF.FF.FF */
    if (ip_address = = 0xFFFFFFFF )
        branch invalid_address;
/*Check whether ip_address equals 00.XX.XX.XX */
    Right-shift ip_address by 24 bits
    if (ip_address = = 0x0)
        branch invalid_address;
/*Check whether ip_address equals 7F.XX.XX.XX */
    Right-shift ip_address by 24 bits
    if (ip _address = = 0x7F)
        branch invalid_address;
/*Check whether ip_address equals EX.XX.XX.XX */
    Right-shift ip_address by 28 bits
    if (ip_address = = 0xE)
        branch invalid_address;
/*Check whether ip_address equals FX.XX.XX.XX */
    Right-shift ip_address by 28 bits
    if (ip_address = = 0xF)
        branch invalid_address;
/* if ip_address doesn't fail above checks then valid IP address*/
    result = VALID_ADDRESS
invalid_address:
    result = INVALID_ADDRESS
}
```

That is, the IP address header portion is first compared to FF.FF.FF.FF. If the IP address header portion equals FF.FF.FF.FF, the result is set to “INVALID_ADDRESS” (e.g., meaning that the IP address is invalid and therefore the packet header is invalid). The first eight bits of the IP address (e.g., the bits remaining after the IP address is shifted right by 24 bits) are then compared to 00. If the first eight bits of the IP address equal 00, the result is set to “INVALID_ADDRESS.” Similar checks are made by comparing the first eight bits to 7F (and then comparing first four bits to E and F). Only if the IP address passes all of these checks is result set to “VALID_ADDRESS.”

Such an approach, however, can be time consuming. That is, it may take a significant number of clock cycles for the network processor to perform each of these checks separately—making it difficult to process information packets fast enough for a relatively high speed network. Moreover, changes to the protocol can be difficult to implement (e.g., the instructions may need to be manually altered to implement the changes).

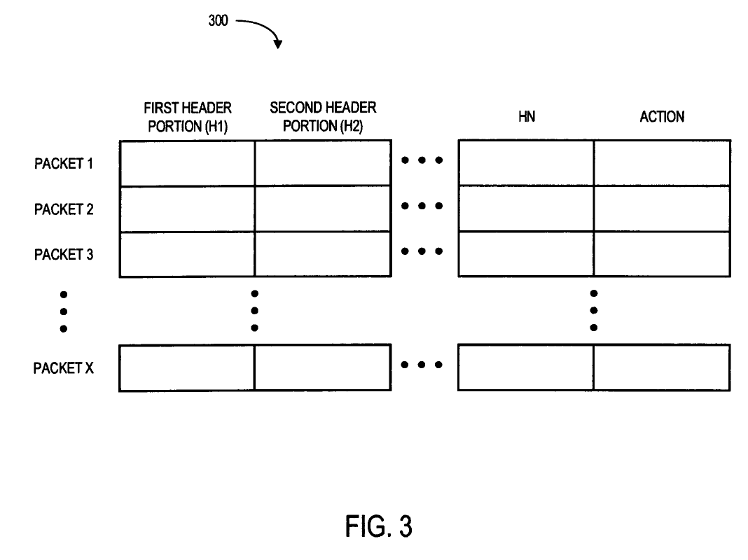

FIG. 3 illustrates a packet header portion database 300 according to some embodiments. The illustrations and accompanying descriptions of the databases presented herein are exemplary, and any number of other database arrangements could be employed besides those suggested by the figures.

In this embodiment, the packet header portion database 300 includes a row or entry for each packet being processed (packets 1 through X). The number of entries in the database 300 may depend on, for example, the rate at which packets are received and/or the rate at which the packets can be processed.

Each entry includes a number of columns associated with packet header portions (header portions H1 through HN). In addition, each entry includes an “Action” column that may, for example, indicate an action to be taken with respect to that packet (e.g., whether the packet is to be dropped or processed).

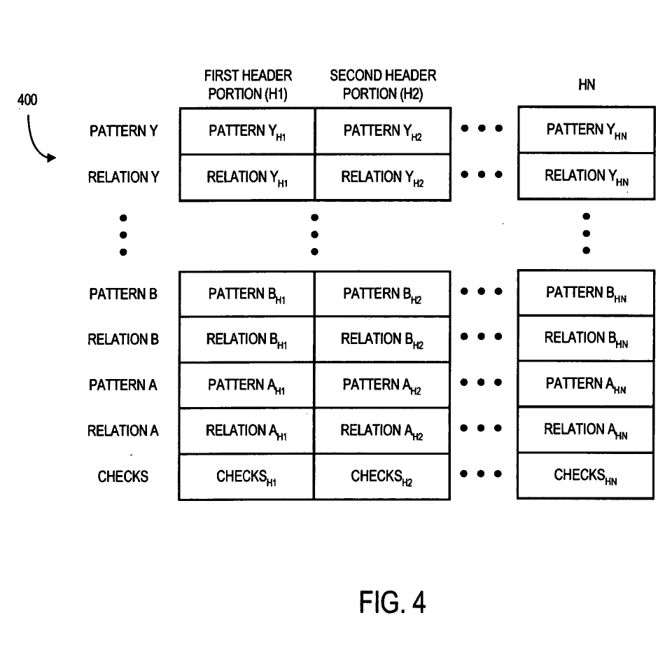

The packet header portion database 300 may be considered two dimensions of information (the packets representing one dimension and the header portions representing another dimension). FIG. 4 illustrates a third dimension of header verification according to some embodiments. In particular, a packet header check database 400 may have columns associated with each of the header portions described with respect to FIG. 3 (H1 through HN).

For each column, the database 400 stores a number of checks that will need to be performed with respect to that header portion (CHECKS_{H1} through CHECKS_{HN}). Moreover, for each check the database 400 stores a RELATION and a PATTERN that check whether the header portion is valid or not. For example, the RELATION and PATTERN might indicate that the header portion is invalid when it equals (the RELATION) FF (the PATTERN).

Consider a protocol in which the first header portion H1 is invalid when it: (i) equals 00, (ii) equals 01, or (iii) is greater than 7F. In this case, CHECKS_{H1} would equal three and the following PATTERNS and RELATIONS could be stored in the database 400:
RELATION A_{H1}: equals
PATTERN A_{H1}: 00
RELATION B_{H1}: equals
PATTERN B_{H1}: 01
RELATION C_{H1}: greater than
PATTERN C_{H1}: 7F
   The network processor may then perform these three checks for each packet header (and determine that the packet header is invalid when any of the three checks fail). Note that a change in the protocol might only require an adjustment to the information stored in the packet header check database 400.

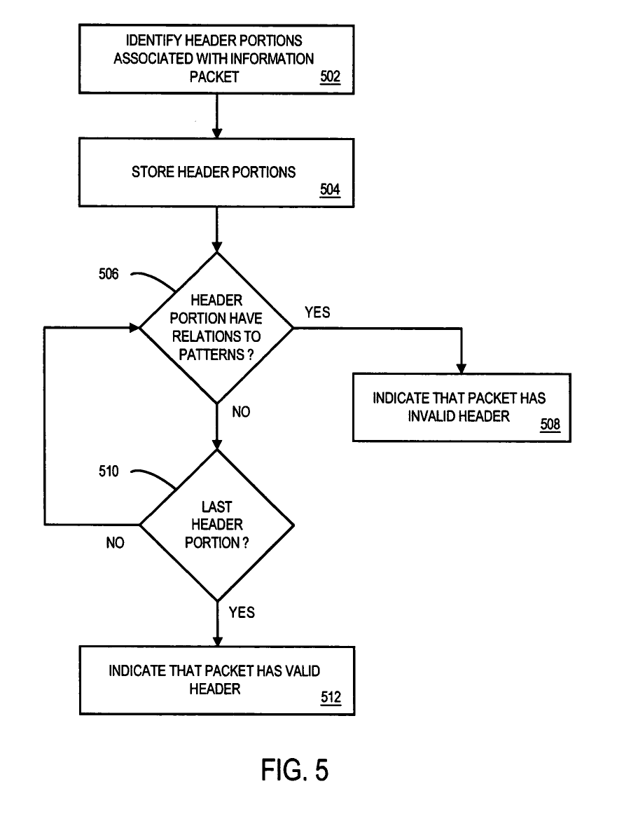

FIG. 5 is a flow chart of a method according to some embodiments. The flow charts described herein do not necessarily imply a fixed order to the actions, and embodiments may be performed in any order that is practicable. Note that any of the methods described herein may be performed by hardware, software (including microcode), or a combination of hardware and software. For example, a storage medium may store thereon instructions that when executed by a machine result in performance according to any of the embodiments described herein.

At 502, header portions associated with an information packet are identified. For example, the network processor may split a packet header into multiple header portions. The header portions are then stored at 504 (e.g., the header portions may be stored in the header portion database 300).

A check is then performed to determine if the first header portion has any of a set of pre-determined relationships to stored patterns at 506. Based on information in the packet header check database 400, for example, the check might determine whether the first header portion equals “FFFF.” As another example, the check might determine if the first header portion is not equal to “02.”0 Note that the a number of different checks (e.g., associated with different types of relationships with different stored patterns) could be performed for the first header portion. If the first header portion has any of the relationships with the associated stored patterns, an indication that the packet header is invalid is provided at 508.

If the first header portion does not have any of the relationships with the stored patterns, it is then determined if any other header portions need to be checked at 510. If there are other header portions to be checked, the process repeats at 506 for the next header portion. When the last header portion has been checked, an indication that the packet header is valid is provided at 512.

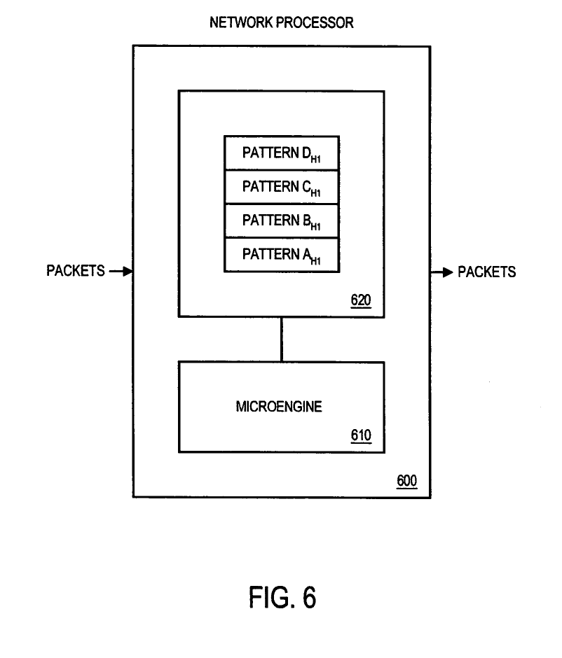

In some cases, the network processor may need to perform a check to make sure that a header portion does not match any of a plurality of patterns. For example, a packet header might be invalid if a particular header portion equals 00, 01, or FF. In this case, the network processor could perform three separate checks. FIG. 6 is a block diagram of a network processor 600 according to another embodiment. The network processor 600 includes a microengine 610, such as a Reduced Instruction Set Computer (RISC) processing element.

The microengine 610 can access information in a Content Addressable Memory (CAM) unit 620 (also referred to as an associative memory unit). The CAM unit 620 may be, for example, a sixteen-entry table (each entry having 32 bits) that can be accessed using the data contained in the table. For example, the CAM unit 620 illustrated in FIG. 6 stores four patterns (PATTERN A_{H1} through D_{H1}). If the microengine 610 provides any of those patterns to the CAM unit 620, the CAM unit 620 will indicate that it currently stores that pattern. If the microengine 610 provides any other pattern to the CAM unit 620, the CAM unit 620 will indicate that it is not currently storing that pattern (e.g., a “miss” signal will be generated).

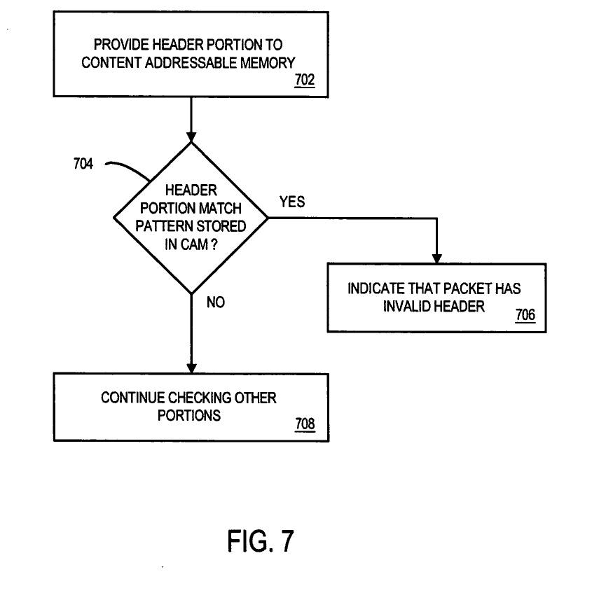

FIG. 7 is a flow chart of a method according to this embodiment. At 702, a header portion being checked is provided to the CAM unit 620. If the CAM unit 620 indicates that the header portion matches any of the stored patterns at 704, an indication that the packet header is invalid is provided at 706. If the CAM unit 620 indicates that the header portion does not match any of the stored patterns at 704, an indication that the packet header is valid is provided at 708 (assuming no other checks fail for that packet header). In this way, the header portion check can be performed simultaneously for multiple stored patterns.

Consider, for example, the IPv4 IP address, which is not allowed to equal: FF.FF.FF.FF, 00.XX.XX.XX, 7F.XX.X.XX, 0E.XX.XX.XX, or 0F.XX.XX.XX. In this case, the following could be performed to verify the IP address:

```
/* Load CAM unit with address check patterns. The initialization
of the CAM unit is a one time activity, which is done before processing
any data packets. */
    Cam_Init( )
    {
        load_cam with 0xFFFFFFFF, 0x0, 0x7F, 0xE and 0xF address
    check patterns
    }
IPv4_new_address_verify (result, ip_address)
{
    /*Check whether ip_address equals FF.FF.FF.FF */
        if (cam has ip_address pattern )
            branch invalid_address;
    /*Check whether ip_address equals 0x0 or 0x7F */
        Right-shift ip_address by 24 bits
            if (cam has ip_address pattern )
                branch invalid_address;
    /*Check whether ip_address equals 0xEX or 0xFX*/
        Right-shift ip_address by 28 bits
            if (cam has ip_address pattern )
                branch invalid_address;
/* if ip_address doesn't match with above conditions then valid IP
address*/
    result = VALID_ADDRESS
invalid_address:
    result = INVALID_ADDRESS
}
```

Note that in this case, the microengine 610 uses the CAM unit 620 to simultaneously determine if the IP address equals 00.XX.XX.XX or 7F.XX.X.XX. Similarly, the CAM unit 620 is used to determine if the IP address equals EX.XX.XX.XX or FX.XX.XX.XX at the same time. As a result, information packets may be processed quickly and using fewer processing cycles.

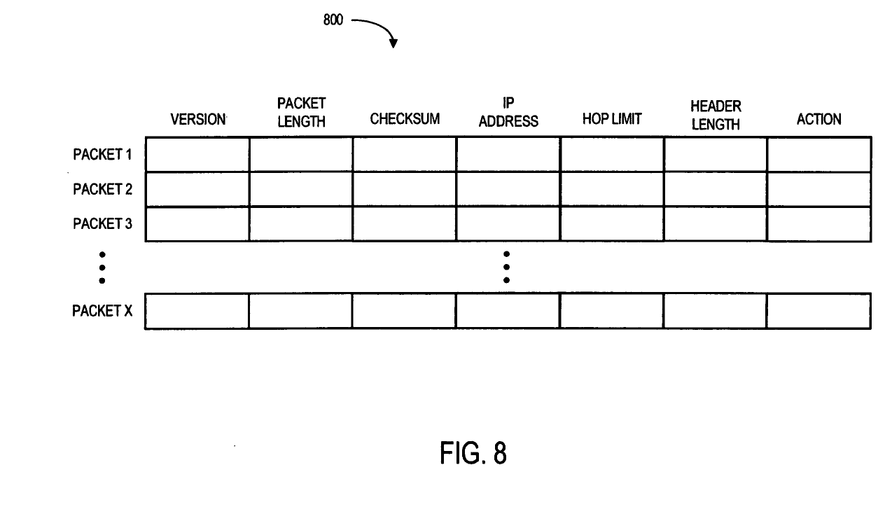

FIG. 8 illustrates an IPv4 packet header portion database 800 in which a packet header is verified in accordance with the “must” and “should” requirements of RFC 1812. For each packet, the database 800 stores a version, a packet total length, a checksum, an IP address, a hop limit, a header length, and an action.

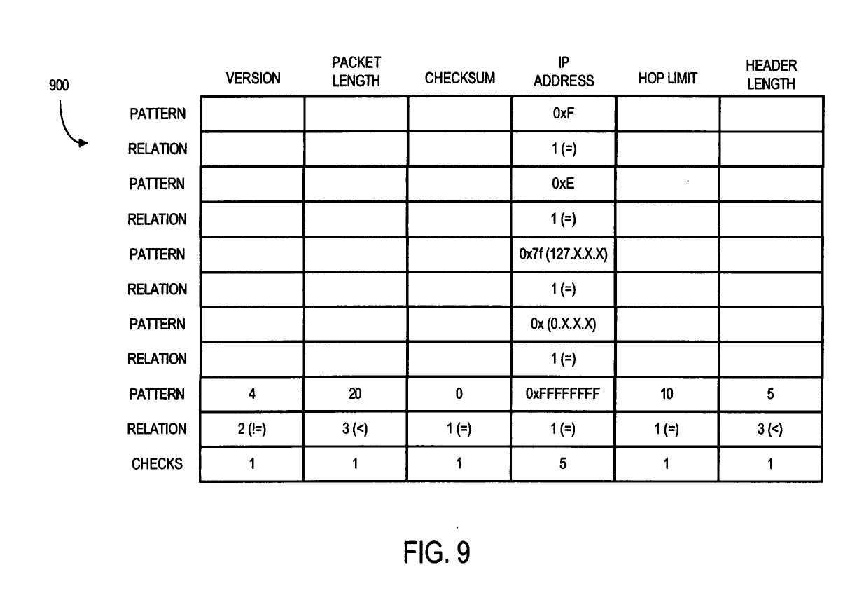

FIG. 9 illustrates an IPv4 packet header check database 900 according to this embodiment. In this case, a RELATION of “1” indicates that the packet header is invalid if the header portion equals the stored pattern. Similarly, a RELATION of “2” indicates that the packet header is invalid if the header portion does not equal the stored pattern. Finally, a RELATION of “3” indicates that the packet header is invalid if the header portion is less than the stored pattern. Note that other types of relationships could be defined as appropriate (e.g., greater than or equal to).

Thus, the “version” header portion of each packet header is compared to a pattern representing “4” (e.g., 0100), and the packet header is determined to be invalid if the check fails (that is, if the version header portion does not equal “0100”). Note that some or all of the patterns for the IP address could be stored in a CAM unit as described with respect to FIGS. 6 and 8.

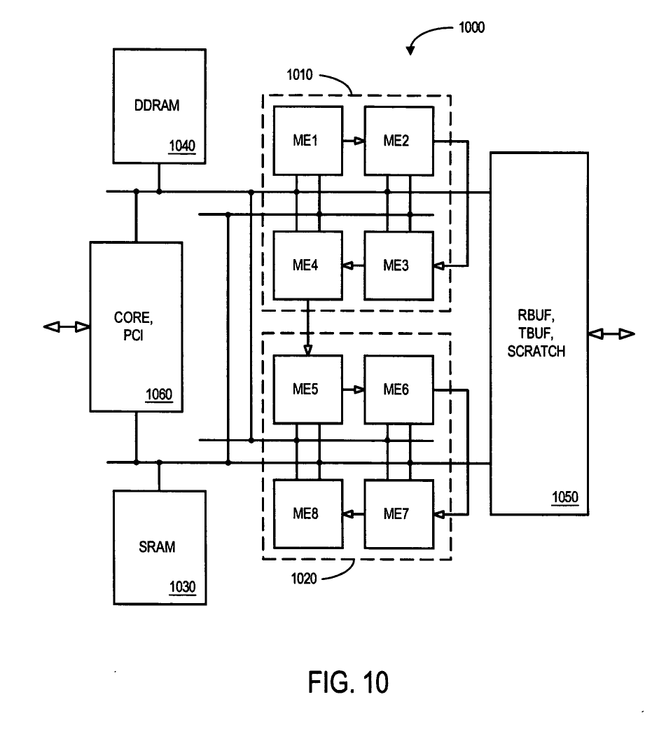

FIG. 10 illustrates a network processor 1000 according to some embodiments. The network processor includes two clusters 1010, 1020, each having four microengines. One or more of the microengines may, for example, perform a packet header verification process in accordance with any of the embodiments described herein.

Each microengine can exchange information with an SRAM unit 1030 and a Double Data Random Access Memory (DDRAM) unit 1040. The network processor 1000 may also include a core processor and/or a Peripheral Component Interconnect (PCI) unit 1060 in accordance with the PCI Standards Industry Group (SIG) documents entitled “Conventional PCI 2.2” or “PCI Express 1.0.” The core processor may comprise, for example, a general purpose 32-bit RISC processor that can be used to initialize and manage the network processor 1000 (e.g., an INTEL® XSCALE™ core). In addition, the microengines may exchange information using receive buffers (RBUFs) to store information received by the network processor 1000, transmit buffers (TBUFs), and/or a scratch memory unit 1050.

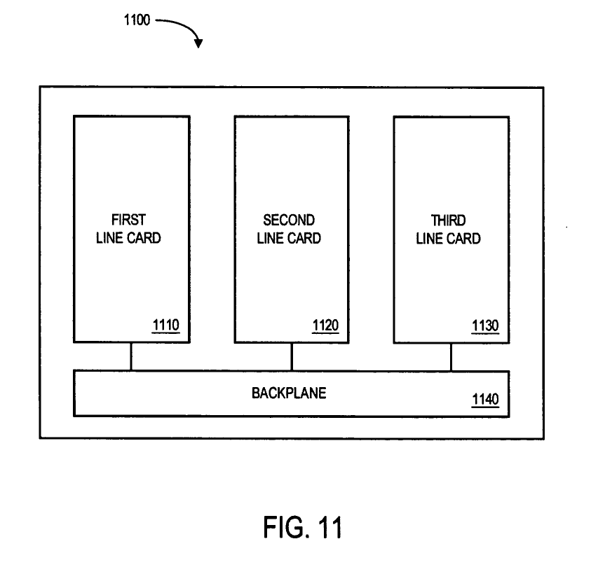

FIG. 11 is an example of a system 1100 according to some embodiments. The system 1000 may comprise, for example, a media gateway, a carrier-class voice over packet gateway, or any other type of network device. The system 1100 includes a number of line cards 1110, 1120, 1130 that exchange information via a backplane 1140. The line cards may, for example, exchange information through one or more networks (e.g., via T1, E1, and/or J1 interfaces). The backplane may, for example, include a PCI and/or a Time-Division Multiplexing (TDM) bus.

At least one of the line cards may operate in accordance with any of the embodiments described herein. For example, the first line card 1110 might include a network processor that has a first memory unit to store a first header portion and a second header portion of a packet header. A second memory unit might then store (i) a first pre-determined relationship and associated first stored pattern for the first header portion and (ii) a second pre-determined relationship and associated second stored pattern for the second header portion.

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

Although some examples have been provided with respect to IPv4, embodiments may be used with respect to any packet header protocol. For example, Frame Relay protocols header verification (e.g., Data Link Connection Identifier (DLCI) information may be stored in CAM) or ATM protocols header verification (e.g., Virtual Path Identifier/Virtual Channel Identifier (VPI/VCI) information may be stored in CAM) might be performed using any of the embodiments described herein.

The several embodiments described herein are solely for the purpose of illustration. Persons skilled in the art will recognize from this description other embodiments may be practiced with modifications and alterations limited only by the claims.

1. A method, comprising:
identifying a first header portion and a second header portion of a packet header for an information packet;
storing the first header portion and the second header portion;
checking if the first header portion has a first pre-determined relationship to a first stored pattern associated with the first header portion; and
checking if the second header portion has a second pre-determined relationship to a second stored pattern associated with the second header portion.

2. The method of claim 1, wherein a plurality of pre-determined relationships and stored patterns are associated with the first header portion.

3. The method of claim 2, wherein the pre-determined relationships associated with the first header portion indicate that the first header portion should not equal any of the stored patterns associated with the first header portion.

4. The method of claim 3, wherein the stored patterns associated with the first header portion are stored in a content addressable memory unit.

5. The method of claim 4, wherein the first header portion check is performed simultaneously for all of the stored header patterns that are associated with the first header portion by providing the first header portion to the content addressable memory unit.

6. The method of claim 1, further comprising:
generating an indication that the information packet has an invalid packet header if either the first header portion check or the second header portion check fails.

7. The method of claim 1, wherein the packet header is associated with at least one of: (i) an Internet protocol network, (ii) an asynchronous transfer mode network, and (iii) a frame relay network.

8. The method of claim 1, wherein an action identifier is stored along with the first header portion and the second header portion.

9. The method of claim 1, wherein the action identifier indicates whether the associated packet should be processed or dropped.

10. The method of claim 1, wherein a memory unit stores an indication of the first pre-determined relationship along with the first stored pattern for the first header portion.

11. The method of claim 10, wherein the memory unit stores a plurality of pre-determined relationships and associated stored patterns for the first header portion.

12. The method of claim 11, wherein the memory unit further stores an indication of the number of pre-determined relationships and stored patterns that are associated with the first header portion.

13. An article, comprising:
a storage medium having stored thereon instructions that when executed by a machine result in the following:
identifying a first header portion and a second header portion of a packet header for an information packet,
storing the first header portion and the second header portion,
checking if the first header portion has a first pre-determined relationship to a first stored pattern associated with the first header portion, and
checking if the second header portion has a second pre-determined relationship to a second stored pattern associated with the second header portion.

14. The article of claim 13, wherein a plurality of pre-determined relationships and stored patterns are associated with the first header portion.

15. The article of claim 14, wherein the pre-determined relationships associated with the first header portion indicate that the first header portion should not equal any of the stored patterns associated with the first header portion.

16. The article of claim 15, wherein the stored patterns associated with the first header portion are stored in a content addressable memory unit.

17. The article of claim 16, wherein the first header portion check is performed simultaneously for all of the stored header patterns that are associated with the first header portion by providing the first header portion to the content addressable memory unit.

18. An apparatus, comprising:
a first memory unit to store a first header portion and a second header portion of a packet header for an information packet; and
a second memory unit to store (i) a first pre-determined relationship and associated first stored pattern for the first header portion and (ii) a second pre-determined relationship and associated second stored pattern for the second header portion.

19. The apparatus of claim 18, wherein the first and second memory units comprise a single device.

20. The apparatus of claim 18, wherein a plurality of stored patterns are associated with the first header portion.

21. The apparatus of claim 20, wherein the first header portion should not equal any of the stored patterns associated with the first header portion.

22. The apparatus of claim 21, wherein stored patterns associated with the first header portion are stored in a content addressable memory unit.

23. A system, comprising:
a backplane;
a first line card connected to the backplane; and
a second line card connected to the backplane, the second line card having a network processor that includes:
a first memory unit to store a first header portion and a second header portion of a packet header for an information packet, and
a second memory unit to store (i) a first pre-determined relationship and associated first stored pattern for the first header portion and (ii) a second pre-determined relationship and associated second stored pattern for the second header portion.

24. The system of claim 23, wherein the first and second memory units comprise a single device.

25. The system of claim 23, wherein a plurality of stored patterns are associated with the first header portion.

26. The system of claim 25, wherein the first header portion should not equal any of the stored patterns associated with the first header portion.

27. The system of claim 26, wherein stored patterns associated with the first header portion are stored in a content addressable memory unit.
